(19) United States
(12) Patent Application Publication
(10) Pub. No.: US 2005/0008966 A1
(43) Pub. Date: Jan. 13, 2005

(54) Photodefinable polymers for semiconductor applications

(76) Inventors: Robert P. Meagley, Hillsboro, OR (US); Takashi Hirano, Tokyo (JP); Michael D. Goodner, Hillsboro, OR (US)

Correspondence Address: TROP PRUNER & HU, PC, 8554 KATY FREEWAY, SUITE 100, HOUSTON, TX, 77024, US

(21) Appl. No.: 10/616,895

(22) Filed: Jul. 10, 2003

(51) Int. Cl. G03C 1/76

(52) U.S. Cl. 430/270.1

(57) ABSTRACT

A polymer system for semiconductor applications may be formed by blending a filler material including Zirconia or silica and a polybenzoxazole precursor for a photodefinable polymer. The filler may be chosen so as not to adversely affect the photodefinability of the resulting system and, in some embodiments, may improve the mechanical or chemical properties of the resulting system.

### BACKGROUND

This invention relates generally to the fabrication of integrated circuits.

In the fabrication of integrated circuits, it is desired to pattern various structures defined on a substrate. This patterning may involve the exposure of photodefinable layers to an energy source such as light or other radiation. The exposed layers react upon exposure and either become more or less easily removed.

Examples of applications for photodefinable materials in semiconductor fabrication include photoresists, dry film resists, buffer coatings, and photodefinable dielectrics.

Existing photodefinable buffer coating for use in semiconductor applications have less than optimal mechanical and chemical properties. For example, the modulus and chemical resistance of some buffer coating materials is insufficient, resulting in mechanical or chemical failure under certain circumstances.

Thus, there is a need for better ways to make photodefinable buffer coatings for semiconductor applications.

### DETAILED DESCRIPTION

In accordance with one embodiment of the present invention, a photodefinable buffer coating may comprise polybenzoxazole (PBO) and PBO precursors. The precursor is an uncured polymer and may be blended with filler and then cured to form a chemically modified polymer layer.

The filler contributes advantageous mechanical and chemical properties such as improved modulus or improved chemical resistance to the system. In addition, the filler advantageously adheres well to the matrix. Furthermore, a surface treatment may be applied to the filler to promote adhesion to the matrix material and/or to facilitate blending.

In some embodiments, the filler may have a relatively small particle size so as to be non-scattering to the radiation used to photodefine the resulting composite system. Thus, in some embodiments, the filler may have a particle size less than 100 nanometers and in other embodiments, the filler may have a particle size less than 20 nanometers. In accordance with one embodiment of the present invention, the filler may be silica particles. In other embodiments of the invention, the filler may be zirconia particles.

The use of silica or zirconia particles may be advantageous in some embodiments because they can contribute good chemical resistance to solvent-based strippers, increased transparency, and low coefficient of thermal expansion to the final formulation. In one embodiment, Zirconia particles approximately 13 nanometers in diameter may be incorporated into the system at from about 9 to about 20 percent by weight. The resulting composite polymer system, consisting of the filler and polymer, may then be utilized as a buffer coating.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
blending a photodefinable polybenzoxazole precursor with a filler having a particle size of less than 100 nanometers.

2. The method of claim 1 including blending the photodefinable precursor with a filler consisting of zirconia particles.

3. The method of claim 1 including blending the photodefinable precursor with a filler consisting of silica particles.

4. The method of claim 1 including blending the photodefinable precursor with a filler having a particle size less than 20 nanometers.

5. The method of claim 1 including blending the photodefinable precursor with a filler having a particle size of about 13 nanometers.

6. The method of claim 1 including curing the precursor after blending with a filler.

7. The method of claim 1 including blending the precursor with a filler so that the filler constitutes from about 9 to about 20 percent by weight.

8. The method of claim 1 including forming a polymer from said blended precursor and filler.

9. A photodefinable polymer for semiconductor applications comprising:
a photodefinable polybenzoxazole precursor; and
a filler material having a particle size of less than 100 nanometers.

10. The polymer of claim 9 wherein said filler material consists of zirconia.

11. The polymer of claim 9 wherein said filler material consists of silica.

12. The polymer of claim 9 wherein said filler material has a particle size of less than 20 nanometers.

13. The polymer of claim 9 wherein said filler material has a particle size of about 13 nanometers.

14. The polymer of claim 9 wherein said filler material comprises from about 9 to about 20 percent by weight.

15. A photodefinable polymer for semiconductor applications comprising:
a photodefinable polybenzoxazole precursor; and
a filler comprising about 9 to about 20 percent of the system, said filler having a particle size of less than 20 nanometers.

16. The polymer of claim 15 wherein said filler consists of zirconia particles.

17. The polymer of claim 15 wherein said filler consists of silica particles.

18. The polymer of claim 15 wherein said filler has a particle size of approximately 13 nanometers.

19. A polymer precursor for semiconductor applications comprising:
a photodefinable polybenzoxazole precursor; and
a filler material having a particle size of less than 100 nanometers.

20. The polymer of claim 19 wherein said filler consists of zirconia particles.

21. The polymer of claim 19 wherein said filler consists of silica particles.

22. The precursor of claim 19 wherein said filler material has a particle size of less than 20 nanometers.

23. The precursor of claim 19 wherein said filler material has a particle size of about 13 nanometers.

24. The precursor of claim 19 wherein said filler material comprises about 9 to about 20 percent by weight.

25. An integrated circuit comprising:
a substrate; and
a photodefinable polymer formed on said substrate, said polymer including a photodefinable resin and a filler material having a particle size of less than 100 nanometers.

26. The circuit of claim 25 wherein said filler material consists of zirconia particles.

27. The circuit of claim 25 wherein said filler material consists of silica particles.

28. The circuit of claim 25 wherein said filler material has a particle size of less than 20 nanometers.

29. The circuit of claim 25 wherein said filler material has a particle size of about 13 nanometers.

30. The circuit of claim 25 wherein said filler material comprises from about 9 to about 20 percent by weight.
